(19) United States
(12) Patent Application Publication
(10) Pub. No.: US 2024/0372118 A1
(43) Pub. Date: Nov. 7, 2024

(54) MONITORING AN ION FILTER FOR A FUEL CELL COOLING CIRCUIT

(71) Applicant: SIEMENS MOBILITY GMBH, München (DE)

(72) Inventors: De-Niang Maria Peymandar, Mönchengladbach (DE); Christian Bedau, Berlin (DE)

(21) Appl. No.: 18/688,870

(22) PCT Filed: Aug. 30, 2022
(86) PCT No.: PCT/EP2022/074052

§ 371 Date: Mar. 4, 2024

(30) Foreign Application Priority Data
Sep. 2, 2021 (DE) 10 2021 209 653.0

(51) Int. Cl. H01M 8/04029; B01J 47/14; H01M 8/04044; H01M 8/04664

(52) U.S. Cl. CPC H01M 8/04029; B01J 47/14; H01M 8/04044; H01M 8/04686; H01M 2250/20

(57) ABSTRACT

In order to monitor the effectiveness of an ion filter by way of at least two conductivity sensors that are disposed upstream and downstream of the ion filter, a characteristic variable correlating with the effectiveness of the ion filter is determined from the measured values of the conductivity sensors and a signal is output if the characteristic variable deviates from a predefined value or interval. As a result, condition-based maintenance is made possible, for example in the case of a cooling circuit of a fuel cell system.

The invention relates to an arrangement and a method for monitoring the effectiveness of an ion filter. In particular, its load and/or its probable remaining service life can be determined thereby, as a result of which condition-based maintenance is enabled.

Ion filters are used to deionize water or other liquids and are employed in specific industrial processes in which an excessive concentration of ions in the liquid disrupts or even prevents the process. One example of this is processes that use a cooling method, and in which the coolant comes into contact with components that are damaged by an excessive concentration of ions, for example corrode faster. A high concentration of ions is generally associated with increased conductivity, which likewise can damage the process or the process installation.

An ion filter has a limited useful life. The longer it is used, the less its effectiveness, since its load increases due to the absorption of filtered-out ions, i.e. the liquid is no longer deionized sufficiently, so that the conductivity of the cooling medium increases.

A typical application is fuel cells, which are preferably cooled with water and are employed as an energy source for many installations, increasingly also for motor vehicles or rail vehicles. In this case the cooling medium comes into direct contact with the cell voltage and also acts as an insulating medium, so it must have only a low electrical conductivity. Thanks to the ion filter, which mostly works as an ion exchanger, a conductivity in the range of approx. 5-15 μS/cm, preferably approx. 10 μS/cm, is reached. This low conductivity is necessary for the operation of a liquid-cooled fuel cell stack; in other applications for ion filters the requirements may be less and conductivities up to 50 μS/cm may be sufficient. The fuel cell stack consists of multiple membranes, and bipolar and cooling plates. The chemical energy from the hydrogen fuel is converted into electrical energy at the membrane. Since the cooling plates and bipolar plates are switched in series, there is a risk of a short-circuit if the conductivity of the cooling medium is too high. For this reason, the use of ion filters in the fuel cell system is essential.

To ensure the low conductivity of the cooling water, the ion filter is replaced at relatively short and fixed intervals predefined by the manufacturer. This is associated with costs and downtimes, which disrupt the operating procedure. This is also the case for other intended uses of ion filters.

The object of the invention is to prevent the disadvantages mentioned.

This object is achieved by an arrangement with the features of claim 1 and by a method with the features of claim 9.

Advantageous embodiments of the invention are specified in the subclaims.

The invention provides for monitoring an ion filter in respect of its effectiveness. The effectiveness, i.e. the filter effect of the ion filter and thus the possible remaining useful life, depends primarily on its actual service life, in other words for example the operational period of the fuel cell. By determining the actual condition, it is possible to dispense with short and fixed replacement intervals, instead of which the ion filter can be used for as long as it still has the requisite effectiveness in the respective application. Thanks to the invention, condition-based maintenance is therefore possible.

An arrangement for determining the effectiveness of an ion filter comprises at least two conductivity sensors, the first conductivity sensor being arranged upstream of the ion filter in the direction of flow and the second conductivity sensor being arranged downstream of the ion filter in the direction of flow. An evaluation unit is provided, which from the measured values of both conductivity sensors can determine a characteristic variable that correlates with the effectiveness of the ion filter. If this deviates from a predetermined value or interval, in particular if it falls below a first lower or upper threshold value, a signal, i.e. electrical or electronic information, is generated that the effectiveness of the ion filter is no longer sufficient. The signal then shows that the ion filter needs to be replaced.

Multiple permitted intervals and/or multiple lower and/or upper threshold values can be predefined, which correlate with different residual effectivenesses or loads, and to which different warning levels regarding the urgency of the replacement are linked. In this case different signals are preferably generated depending on the warning level. As a result, the replacement of the filter can be better integrated into the operating procedure.

For example, the evaluation unit can determine the difference between the measured values of the first and second conductivity sensor or variables derived therefrom as a characteristic variable.

The conductivity sensors can measure the conductivity of a cooling medium, for example water. The second conductivity sensor can be arranged upstream or downstream of the component to be cooled. If a sensor is arranged between the ion filter and the component to be cooled, in particular a fuel cell, it is possible to use its measured value to ensure that the conductivity is sufficiently low for the operation of the fuel cell.

An arrangement with three conductivity sensors is advantageous, these for example being arranged upstream of the ion filter, between the ion filter and the component to be cooled, and downstream of the component to be cooled. Multiple conductivity sensors are also advantageous if multiple ion filters are to be monitored in a flow of liquid, since the condition of separate ion filters can then be monitored individually.

Furthermore, one of the two conductivity sensors or an additional conductivity sensor can then be arranged sufficiently directly upstream of a component, in particular upstream of the component to be cooled, and using its measured value it is possible to determine whether the liquid medium, in particular the cooling medium, has a sufficiently low conductivity in order not to damage the component. To this end it is provided that a corresponding signal is output by the evaluation unit.

The conductivity sensors can have a data interface, via which they are connected to a controller, for example a controller for the component to be cooled or a higher-level controller. The connection to the controller can take place directly or indirectly, in particular via the evaluation unit. As a result, an improved incorporation into the overall process with a comprehensive diagnostic system is possible. As a result, further possibilities for a method for sampling and temporarily storing the measured values are opened up, which can be easily adapted in the higher-level controller in accordance with the operation and maintenance/upkeep strategy.

When used in a vehicle the conductivity sensors can easily be supplied by the vehicle's on-board electrical system. Alternatively or additionally the evaluation unit can pass the determined characteristic variable and/or the measured values of the conductivity sensors and/or the signal to a system located outside the vehicle, such as a higher-level central unit, for example a fleet management system. Alternatively or additionally, a driver display can be present, i.e. a display device visible to the driver during the journey, which displays the measured values, the characteristic variable and/or the signal.

In the method for monitoring the effectiveness of an ion filter the conductivity of the liquid medium flowing through it is measured upstream and downstream of the ion filter. The measured values are transmitted to an evaluation unit. A characteristic variable is calculated from the measured values, which correlates with the effectiveness of the ion filter. The characteristic variable is compared to a predefined value or interval, and a signal is output if it deviates from this value in a predefined manner or lies outside the predefined interval.

The possible configurations described in connection with the arrangement also apply analogously for the method. Thus it is for example advantageous to use multiple predefined threshold values or intervals, with different signals being output if these are undershot or exceeded. As a result, a preliminary warning can be output in the event of only a moderate decrease in the effectiveness of the ion filter, and if the load increases further and the effectiveness continues to decrease, further warning levels can be signaled. The ion filter can then be replaced at a time at which the operation of the whole installation is impaired as little as possible, because the necessary replacement of a filter at the end of its useful life is notified in good time.

With the arrangement and the method, predictive monitoring and condition-based maintenance is enabled. The ion filter is only replaced after notification in good time if the effectiveness decreases or at the end of the useful life, and no longer in a generalized manner after a fixed predefined static time interval without reference to the operating hours of the ion filter. At the same time it is ensured that the ion filter is used only for as long as its effectiveness is sufficient for the respective application, and damage is prevented. Furthermore, the service processes are optimized and the storage costs for the ion filters that the operator has to keep in stock are reduced. By using at least two conductivity sensors the condition of the ion filter can be determined very precisely and independently of ambient influences.

The invention is explained in greater detail below using exemplary embodiments. In the drawings

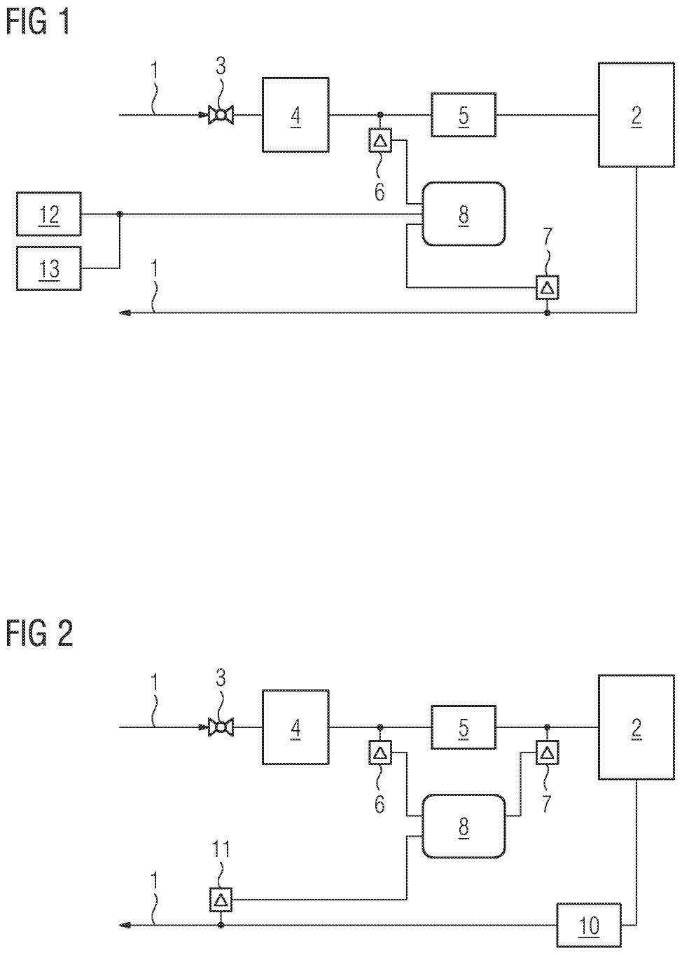

FIG. 1 shows a first exemplary embodiment with one ion filter

FIG. 2 shows a second exemplary embodiment with two ion filters

FIG. 1 shows a section of a cooling circuit with a line 1, through which water flows as a cooling medium, and a fuel cell 2 as a component to be cooled. The cooling circuit has a shut-off device, e.g. a valve 3, and further components not shown for reasons of clarity. For example, a heat exchanger, a coolant pump and further valves, lines and branches may be present at a suitable location. The whole arrangement can be accommodated in a fuel cell container.

The cooling circuit has a particle filter 4 and an ion filter 5, in order sufficiently to clean and deionize the cooling water upstream of the fuel cell. A first conductivity sensor 6 is arranged upstream of the ion filter 5 in the direction of flow, a second conductivity sensor 7 is arranged downstream of the ion filter. In the example shown it is also arranged downstream of the fuel cell 2, but it can also be arranged between the ion filter 5 and the fuel cell 2.

An evaluation unit 8 is connected to both conductivity sensors and receives their measured values. The evaluation unit calculates a characteristic variable from these, which correlates with the filter effect of the ion filter. For example, the characteristic variable is the difference L1−L2 between the measured conductivities L1 of the first sensor and L2 of the second sensor. The evaluation unit compares this characteristic variable to a predefined first lower threshold value S1 and a second lower threshold value S2, where S2 is <S1. The threshold values are preferably stored in the evaluation unit. If the calculated difference is less than S1, an optical and/or acoustic signal or corresponding diagnostic information is for example output as a preliminary warning signal, since the effectiveness of the ion filter has decreased due to its operating hours. If the calculated difference is less than S2, then likewise for example an optical and/or acoustic signal or corresponding further diagnostic information is output as a warning signal, since the effectiveness of the ion filter is reduced even further due to its operating hours and a replacement is necessary.

The system shown is provided for a vehicle with a fuel cell drive, and the signal is displayed to the driver on a driver display 12 and/or is passed to a fleet management system 13 outside the vehicle.

The form of embodiment according to FIG. 2 differs from FIG. 1 by a second ion filter 10 and by a further conductivity sensor 11. The further conductivity sensor 11 is arranged downstream of the second ion filter 10, the second conductivity sensor 7 is arranged downstream of the first ion filter 5 and upstream of the fuel cell 2. As above, the evaluation unit 8 can determine the combined effectiveness of both ion filters 5, 10 from the measured values of the first and of the further sensor. Furthermore, the condition of the first ion filter can be determined using the measured values of the first and of the second conductivity sensor 6, 7. Analogously, the condition of the second ion filter 10 can be determined using the measured values of the second conductivity sensor 7 and of the further conductivity sensor 11. Additionally the evaluation unit 8 can use the measured value of the second conductivity sensor 7 to check whether the cooling water has a sufficiently low conductivity in order not to damage the fuel cell. As described in the first exemplary embodiment it is likewise possible to pass the signal to a driver display and/or a fleet management system, but this is not shown for reasons of clarity

1-18. (canceled)

19. An arrangement for monitoring an effectiveness of an ion filter, the ion filter being configured for a throughflow of a liquid medium in a direction of flow, the arrangement comprising:
a first conductivity sensor arranged upstream of the ion filter in the direction of flow;
a second conductivity sensor arranged downstream of the ion filter in the direction of flow;
an evaluation unit connected to receive measured values from said first and second conductivity sensors, said evaluation unit being configured:
to determine, with the help of the measured values of said first and second conductivity sensors, a characteristic variable that correlates with an effectiveness of the ion filter; and
to output a signal when the characteristic variable deviates from a predefined value or interval.

20. The arrangement according to claim 19, wherein said evaluation unit is configured to emit different signals depending on a value of the characteristic variable.

21. The arrangement according to claim 19, wherein the liquid medium is a cooling medium for a component to be cooled.

22. The arrangement according to claim 21, wherein the component to be cooled is a fuel cell.

23. The arrangement according to claim 21, wherein said second conductivity sensor is arranged upstream of the component to be cooled.

24. The arrangement according to claim 21, wherein said first and second conductivity sensors have a data interface for direct or indirect connection to a controller of the component to be cooled or to a higher-level controller.

25. The arrangement according to claim 19 disposed in a motor vehicle or a rail vehicle and configured to transmit at least one of the characteristic variable or the measured conductivity values or the signal to a higher-level central unit outside the motor vehicle or rail vehicle.

26. The arrangement according to claim 19 disposed in a motor vehicle or a rail vehicle and comprising a display device for displaying at least one of the characteristic variable or the measured conductivity values or the signal on a driver display.

27. The arrangement according to claim 19, comprising at least one further conductivity sensor.

28. A method for monitoring an effectiveness of an ion filter, the method comprising:
conducting a liquid medium through the ion filter in a given direction of flow;
measuring a conductivity of the liquid medium upstream of the ion filter in the direction of flow and downstream of the ion filter in the direction of flow;
determining by an evaluation unit, with the help of the measured conductivities, a characteristic variable that correlates with an effectiveness of the ion filter; and
outputting a signal when the characteristic variable deviates from a predefined value or interval.

29. The method according to claim 28, which comprises predefining multiple values or intervals and assigning to each value or interval a different signal to be output.

30. The method according to claim 28, which comprises measuring the conductivity of a cooling medium for a fuel cell.

31. The method according to claim 28, which comprises:
measuring the conductivity upstream of the ion filter with a first conductivity sensor and measuring the conductivity of the ion filter downstream of the ion filter with a second conductivity sensor; and
determining a difference between measured values of the first and second conductivity sensors; and
outputting the signal when the difference undershoots a predefined threshold value for the difference.

32. The method according to claim 28, wherein the second conductivity sensor is arranged in a cooling circuit upstream of a fuel cell, and the method comprises outputting a signal when a measured value of the second conductivity sensor exceeds a threshold value.

33. The method according to claim 28, wherein the ion filter is arranged in a cooling circuit upstream of a fuel cell and the method comprises transmitting at least one of a determined characteristic variable or measured conductivity values or the signal to a higher-level central unit.

34. The method according to claim 33, which comprises transmitting the determined characteristic variable and/or the measured conductivity values and/or the signal to the higher-level central unit being a fleet management system.

35. The method according to claim 28, wherein the ion filter is arranged in a motor vehicle or in a rail vehicle, and wherein a display device is provided for displaying at least one of the characteristic variable, the measured conductivity values, or the signal on a driver display.

36. The method according to claim 28, which comprises measuring the conductivity of the liquid medium with at least one further conductivity sensor and using the measured value thereof to determine the characteristic variable and/or the conductivity of the medium.

37. A fuel cell system, comprising a fuel cell, a coolant circuit for the fuel cell, and an arrangement according to claim 19.

38. A vehicle, comprising an arrangement according to claim 19.
